(19) United States
(12) Patent Application Publication
(10) Pub. No.: US 2020/0369290 A1
(43) Pub. Date: Nov. 26, 2020

(54) SYSTEM AND METHOD FOR CONFIGURING WORKSITE WARNING ZONES

(71) Applicant: Deere & Company, Moline, IL (US)

(72) Inventor: Mark J. Cherney, Bettendorf, IA (US)

(21) Appl. No.: 16/801,539

(22) Filed: Feb. 26, 2020

Related U.S. Application Data
(60) Provisional application No. 62/850,846, filed on May 21, 2019.

(51) Int. Cl. B60W 50/14; B60R 11/04; G06K 9/00

(52) U.S. Cl. CPC B60W 50/14; B60R 11/04; G06K 9/00805; B60W 2300/15; B60W 2554/404; B60W 2050/143; B60W 2420/52; B60W 2420/403; B60W 2554/20; B60W 2050/146

(57) ABSTRACT

A warning zone system and method is disclosed. The warning zone system can comprise an object detection system, a zone configuration system, and an electronic data processor. The object detection system is arranged on a work vehicle and is configured to detect and classify one or more object obstructions located at a worksite. The zone configuration system is configured to associate position data with the one or more object obstructions and generate object models of the object obstructions based on the associated position data. The electronic data processor is communicatively coupled to each of the object detection system and the zone configuration system and is configured to generate and associate warning zones with each of the object models for display on a user display in near real-time.

### FIELD OF THE DISCLOSURE

The present disclosure relates generally to warning zone systems for work vehicles, and, more particularly, to a system and method for configuring worksite warning zones.

### BACKGROUND OF THE DISCLOSURE

Improving operator safety at industrial worksites, such as construction worksites, is important. To improve operator safety, worksite owners have implemented a variety of safety systems to reduce worksite hazards and to increase the safety of operators within the vehicle, as well as outside the vehicle and around the worksite.

For example, some conventional approaches and techniques employ the use of radar sensors to mitigate safety hazards. Drawbacks to such systems include inaccurate and limited sensing capabilities, and false detection warnings, which can lead to system disengagement or deactivation by an operator based on the false warnings. One way to improve upon these systems is to enable the operator to define warning zones with the machine. Therefore, to overcome the drawbacks, there is a need in the art for a robust and improved warning zone system that provides increased sensing accuracy and substantially real-time monitoring and warning zone configuration.

### SUMMARY OF THE DISCLOSURE

According to an aspect of the present disclosure, a warning zone system for a work vehicle is disclosed. The warning zone system comprises an object detection system arranged on a work vehicle, wherein the object detection system is configured to detect and classify object obstructions located at a worksite; a zone configuration system, wherein the zone configuration system is configured to associate position data with the object obstructions, and generate object models of the object obstructions based on the associated position data; and an electronic data processor communicatively coupled to each of the object detection system and the zone configuration system, wherein the electronic data processor is configured generate and associate warning zones with the object models for display on a user display in substantially real-time.

According to another aspect of the present disclosure, a method is disclosed. The method comprises capturing at least one image of an object obstruction arranged in a worksite; classifying the object obstruction based on a plurality of object characteristics; associating position data with the object obstruction; generating a model of the object obstruction; generating and associating one or more warning zones with the object obstructions; and displaying the warning zones on a user display in substantially real-time.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is an illustration of a work vehicle including a warning zone system for configuring worksite warning zones according to an embodiment;

FIG. 2 is a block diagram of a warning zone system for configuring worksite warning zones according to an embodiment;

FIG. 3 is a block diagram of a vehicle electronics unit according to an embodiment;

FIG. 4 is a flow diagram of a method for configuring worksite warning zones; and

FIG. 5 is an exemplary display of a map illustrating warning zones configured by the warning zone system of FIG. 2.

Like reference numerals are used to indicate like elements throughout the several figures.

### DETAILED DESCRIPTION OF THE DRAWINGS

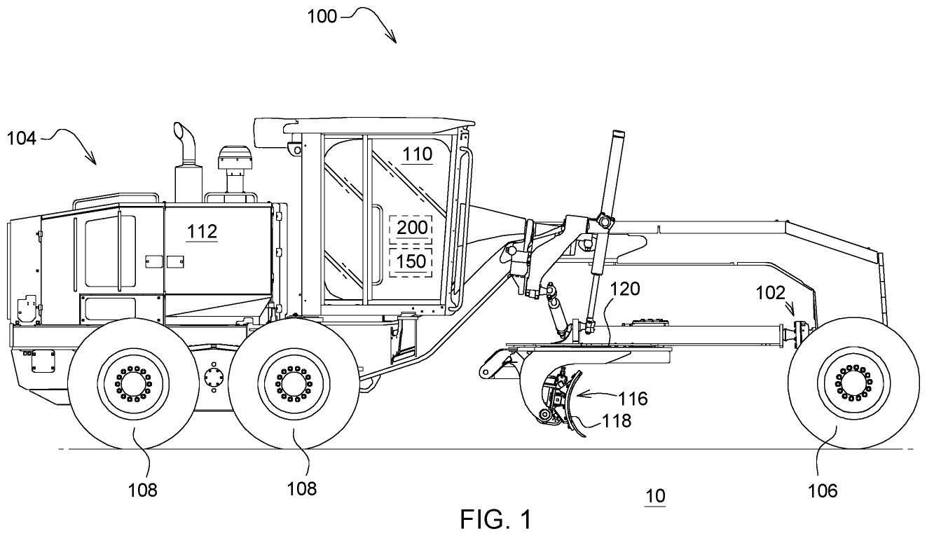

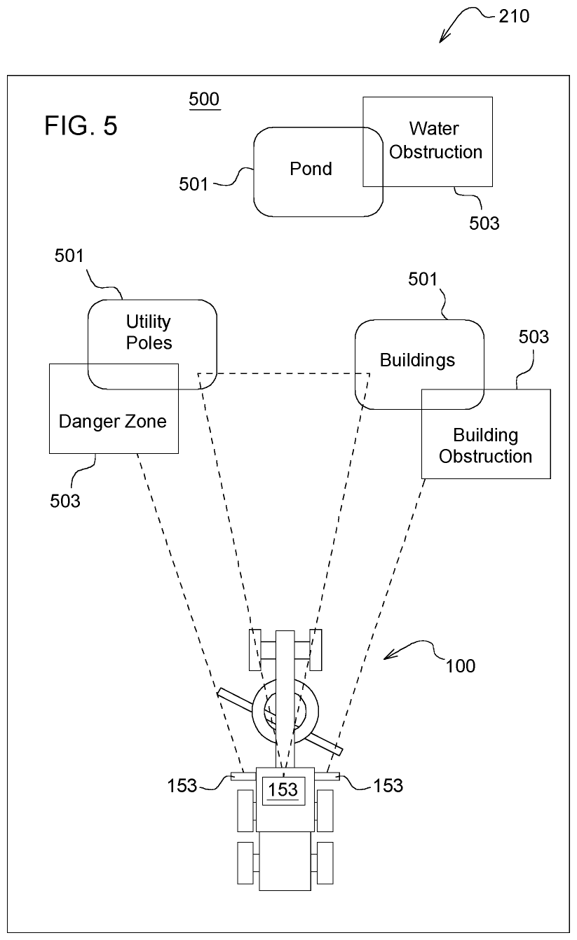

Referring to FIG. 1, a work vehicle 100 having a warning zone system 150 for configuring worksite warning zones 501 (FIG. 5) is shown according to an embodiment. Although the work vehicle 100 is shown as including a construction work vehicle 100 (e.g., a motor grader) in FIG. 1, it should be noted that, in other embodiments, the work vehicle 100 can vary according to application and specification requirements. For example, in other embodiments, the work vehicle 100 can include forestry, agricultural, turf, or on-road vehicles, with embodiments discussed herein being merely for exemplary purposes to aid in an understanding of the present disclosure.

The work vehicle 100 can comprise a frame assembly comprising a first frame 102 (e.g., a front frame) and a second frame 104 (e.g., a rear frame) structurally supported by wheels 106, 108. An operator cab 110, which includes a variety of control mechanisms accessible by a vehicle operator, can be mounted to the first frame 102. An engine 112 can be mounted to the second frame 104 and arranged to drive the wheels 108 at various speeds via coupling through a drive transmission (not shown). As shown in FIG. 1, a blade assembly 116 can be coupled to the first frame 102 and arranged to perform a variety of ground engaging tasks such as pushing, leveling, or spreading of soil at worksite 10. The blade assembly 116 can comprise one or more blades 118 having generally concave shapes coupled to a ring-shaped gear 120. For example, the blades 118 can extend parallel to a ring-shaped gear 120 and can be arranged such that rotation of the ring-shaped gear 120 facilitates movement of the blades 118 relative to the first frame 102.

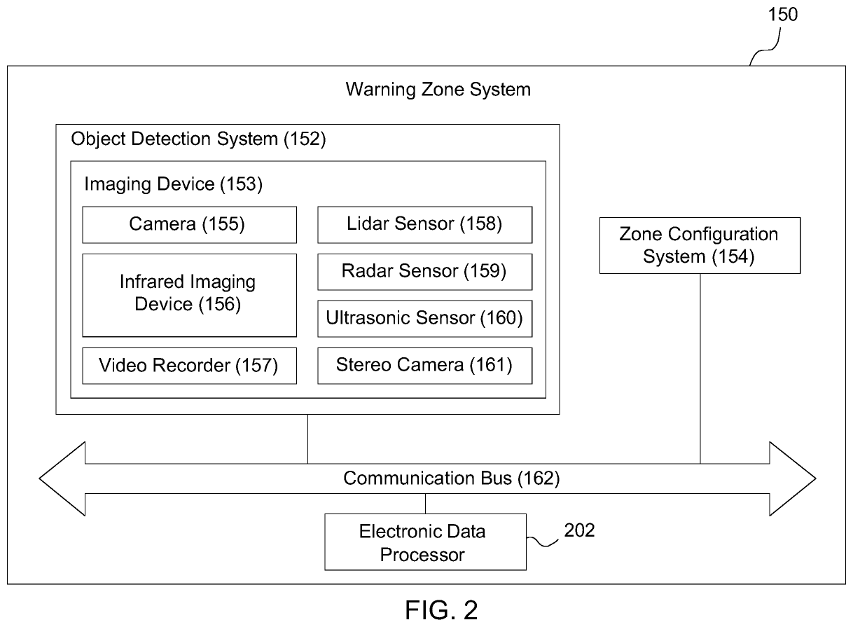

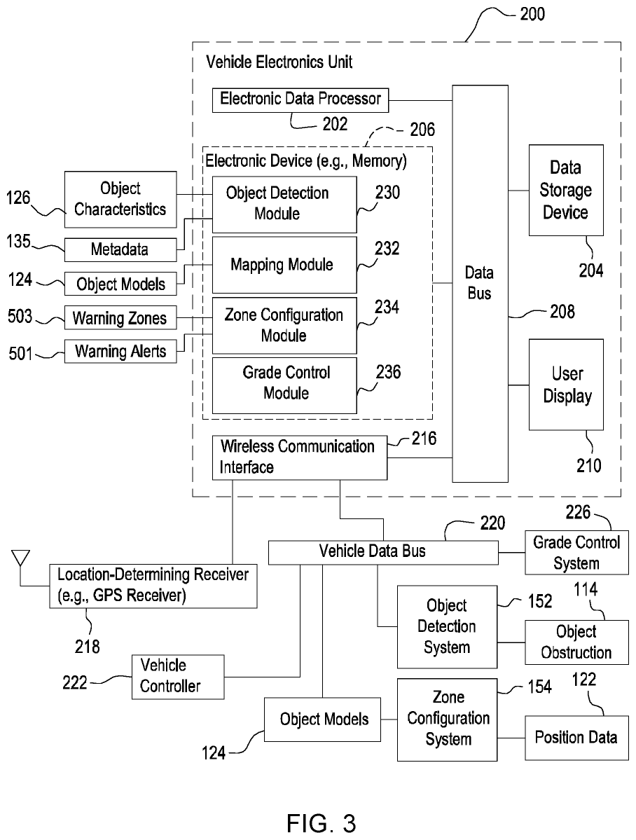

With reference to FIG. 2, in some embodiments the warning zone system 150 can comprise an object detection system 152 and a zone configuration system 154, each communicatively coupled to an electronic data processor 202 to provide substantially, or near real-time graphical depictions of worksite zones and warnings signals to a user via a user display 210 (FIG. 3). In some embodiments, the object detection system 152 can comprise one or more imaging devices 153 such as a camera 155, an infrared imaging device 156, a video recorder 157, a lidar sensor 158, a radar sensor 159, an ultrasonic sensor 160, a stereo camera 161, or other suitable device capable of capturing near real-time images or video of object characteristics 126 (FIG. 3).

As will be appreciated by those skilled in the art, FIGS. 1 and 2 are provided for illustrative and exemplary purposes only and are in no way intended to limit the present disclosure or its applications. In other embodiments, the arrangement and/or structural configuration of the warning zone system 150 can vary. For example, in some embodiments, the warning zone system 150 can comprise additional sensing devices. Further, in other embodiments, the warning zone system 150 can comprise a network of distributed systems arranged on a plurality of work vehicles 100 located at a single worksite (i.e., worksite 10) or several remote worksites.

Referring to FIG. 5, the imaging devices 153 can be mounted in a variety of locations around the work vehicle 100. For example, the imaging devices 153 can be located on a front, rear, side, and/or top panel of the work vehicle 100 to provide for a wide and expansive field of view. In other embodiments, the imaging devices 153 can work collectively with other sensor devices arranged on the work vehicle 100 or auxiliary work vehicles.

As shown in FIG. 2, the zone configuration system 154 can be communicatively coupled to the object detection system 152 via a communication bus 162. The zone configuration system 154 can comprise one or more coordinate or georeferencing sensors or systems that associate image data received by the object detection system 152 with spatial or geographic coordinates. The communication bus 162 can include a vehicle data bus 220, a data bus 208, and a wireless communication interface 216 to enable communication.

For example, with reference to FIG. 3, the zone configuration system 154 can utilize location and position data 122 received from a location determining receiver 218 to generate 2-D or 3-D maps, or object models 124, of the images captured by the object detection system 152. Thus, the zone configuration system 154 is configured to associate position data 122 with the one or more object obstructions 114 and generate object models 124 of the object obstructions 114 based on the associated position data 122 and object characteristics 126.

The electronic data processor 202 can be arranged locally as part of a vehicle electronics unit 200 of the work vehicle 100 or remotely at a remote processing center (not shown). In various embodiments, the electronic data processor 202 can comprise a microprocessor, a microcontroller, a central processing unit, a programmable logic array, a programmable logic controller, or other suitable programmable circuitry that is adapted to perform data processing and/or system control operations. For example, the electronic data processor 202 can be configured to associate a plurality of warning zones 501 (FIG. 5) and/or warning alerts 503 (FIG. 5) with the one or more images captured by the object detection system 152 for display on the user display 210.

With continued reference to FIG. 3, a block diagram of a vehicle electronics unit 200 is shown according to an embodiment. The vehicle electronics unit 200 can comprise the electronic data processor 202, a data storage device 204, an electronic device 206, a wireless communications device 216, the user display 210, a location determining receiver 218, and a vehicle data bus 220 each communicatively interfaced with a data bus 208. As depicted, the various devices (i.e., data storage device 204, wireless communications device 216, user display 210, and vehicle data bus 220) can communicate information, e.g., sensor signals, over the data bus 208 to the electronic data processor 202.

The data storage device 204 stores information and data (e.g., geocoordinates or mapping data) for access by the electronic data processor 202 or the vehicle data bus 220. The data storage device 204 can similarly comprise electronic memory, nonvolatile random-access memory, an optical storage device, a magnetic storage device, or another device for storing and accessing electronic data on any recordable, rewritable, or readable electronic, optical, or magnetic storage medium.

The location-determining receiver 218 may comprise a receiver that uses satellite signals, terrestrial signals, or both to determine the location or position of an object or the vehicle. In one embodiment, the location-determining receiver 218 comprises a Global Positioning System (GPS) receiver with a differential correction receiver for providing precise measurements of the geographic coordinates or position of the work vehicle 100. The differential correction receiver may receive satellite or terrestrial signal transmissions of correction information from one or more reference stations with generally known geographic coordinates to facilitate improved accuracy in the determination of a location for the GPS receiver. In other embodiments, localization and mapping techniques such as simultaneous localization and mapping (SLAM) can be employed. For example, in low receptivity areas and/or indoor environments such as caves, mines, or urban worksites, SLAM techniques can be used to improve positioning accuracy within those areas. Additionally, in other alternative embodiments, sensors such as gyroscopes and accelerometers can be used collectively with or independently of the location-determining receiver 218 to map distances and angles to the images captured by the object detection system 152.

The electronic data processor 202 manages the data transfer between the various vehicle systems and components, which, in some embodiments, can include data transfer to and from a remote processing system (not shown). For example, the electronic data processor 202 collects and processes data (e.g., object characteristic data and mapping data) from the data bus 208 for transmission either in a forward or rearward direction.

The electronic device 206 can comprise electronic memory, nonvolatile random-access memory, flip-flops, a computer-writable or computer-readable storage medium, or another electronic device for storing, retrieving, reading or writing data. The electronic device 206 can include one or more software modules that record and store data collected by the object detection system 152, the zone configuration system 154, or other network devices coupled to or capable of communicating with the vehicle data bus 220, or another sensor or measurement device for sending or measuring parameters, conditions or status of the vehicle electronics unit 200, vehicle systems, or vehicle components. Each of the modules can comprise executable software instructions or data structures for processing by the electronic data processor 202. As shown in FIG. 3, the one or more software modules can include, for example, an object detection module 230, a mapping module 232, a zone configuration module 234, and can optionally include a grade control module 236.

The term module as used herein may include a hardware and/or software system that operates to perform one or more functions. Each module can be realized in a variety of suitable configurations and should not be limited to any particular implementation exemplified herein, unless such limitations are expressly called out. Moreover, in the various embodiments described herein, each module corresponds to a defined functionality; however, in other embodiments, each functionality may be distributed to more than one module. Likewise, in other embodiments, multiple defined functionalities may be implemented by a single module that performs those multiple functions, possibly alongside other functions, or distributed differently among a set of modules than specifically illustrated in the examples herein.

The object detection module 230 records and stores near real-time imaging data collected by the object detection system 152. For example, the object detection module 230 can identify and associate one or more object characteristics 126 such as dimensions, colors, or geometric configurations with the captured images. In some embodiments, the object detection module 230 can identify the object by comparing and associating the captured image to stored data such as metadata 135, image data, or video data.

A mapping module 232 can access the object detection module 230 and associate the identified object obstructions 114 with one or more coordinates or geographic locations. For example, in some embodiments, the mapping module 232 can generate two-dimensional (2D) or three-dimensional (3D) object models 124 of detected object obstructions 114 by utilizing imagery data such as mesh data, location data, coordinate data, or others. In other embodiments, the mapping module 232 can map the entire worksite 10 in 2D or 3D format including the generated 2D or 3D object models 124 of the identified object obstructions 114.

The zone configuration module 234 can associate the generated 2D and 3D object models 124 with warning zones 501. For example, in one embodiment, the zone configuration module 234 can characterize detected object obstructions 114 as active warning zones 501 or operator zones that include one or more site operators or pedestrians located within the zones. This, in turn, can alert a vehicle operator to change course or halt operations of the work vehicle 100. In other embodiments, the zone configuration module 234 can define object obstructions 114 as hazardous or impassable and generate warning alerts 503 notifying a vehicle operator that such zone should not be traveled through during operation of the work vehicle 100.

In additional embodiments, the grade control module 236 can control the orientation of the blade assembly 116. For example, the grade control module 236 can utilize GPS data to adjust a position and orientation of the blades 118 of the blade assembly 116 and output corresponding coordinate data to the mapping module 232.

The vehicle data bus 220 supports communications between one or more of the following components: a vehicle controller 222, the object detection system 152, the zone configuration system 154, a grade control system 226, and the electronic data processor 202 via a wireless communication interface 216.

The vehicle controller 222 can comprise a device for steering or navigating the work vehicle 100 consistent with the grade control system 226 or other instructions provided by the vehicle operator based on feedback received from the object detection system 152 or zone configuration system 154. For example, the grade control system 226 can receive one or more position signals from the location determining receiver 218 arranged on the work vehicle 100 (e.g., the operator cab 110). Additionally, the grade control system 226 can determine a location of the blades 118 and generate command signals communicated to the vehicle controller 222 to change a position of the blades 118 based on signals received from/by the location determining receiver 218. Once the data is received, the electronic data processor 202 can execute software stored in the grade control module 236 to allow for the position data 122 to be mapped to the images captured or cross-referenced with stored maps or models. For example, it should be noted that, in some embodiments, the grade control system 226 can comprise a collection of stored maps and models.

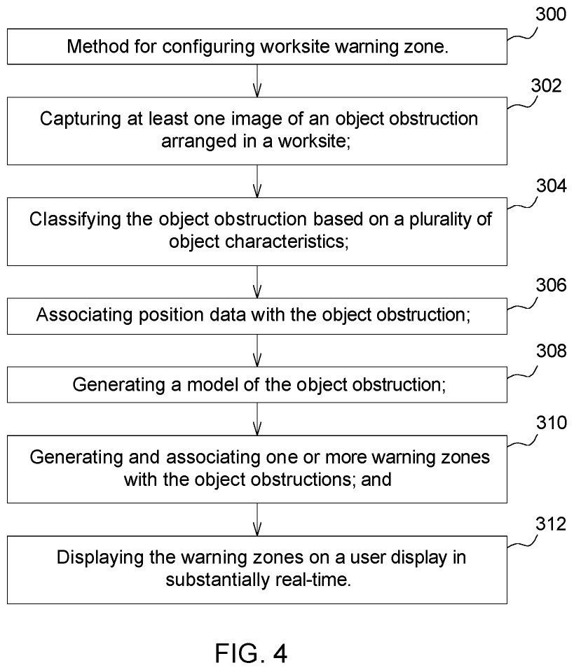

Referring now to FIG. 4, a flow diagram of a method 300 for configuring worksite warning zones is shown. At 302, upon receipt of an input via the user display 210 or upon start-up of the work vehicle 100, one or more imaging devices 153 arranged in the object detection system 152 can be activated. As the work vehicle 100 travels across a worksite 10, the object detection system 152 can receive information about the environment of worksite 10 based on the images captured by the imaging devices 153. For example, images of all stationary object obstructions 114 such as site operators, ponds, dirt mounds, buildings, utility poles, etc., located around the worksite 10 can be captured and stored in data storage device 204.

At 304, the object detection module 230 can classify the images into various categories based on a plurality of object characteristics 126 such as object type 128 (e.g., person, pile, etc.), object size 130, object location 132, combinations thereof, or other suitable object identifying characteristics. In other embodiments, various artificial intelligence and machine learning techniques can be employed to generate the classified data based, for example, on one or more neural networks. Additionally, in other alternative embodiments, an operator may classify the images via a user interface arranged on a portable device such as mobile phone or tablet.

Next at 306, the electronic data processor 202 can access the mapping module 232 and generate 2D or 3D models of the captured images by associating the identified object obstructions 114 with one or more coordinates or geographic locations as discussed above with reference to FIG. 3.

At 308, 2D or 3D models of the detected object obstructions 114 are generated by utilizing imagery data such as mesh data, location data, coordinate data, or others. The mapping module 232 can also input positioning data received directly from the location determining receiver 218 or from the grade control system 226.

In some embodiments, the electronic data processor 202 can receive or transfer information to and from other processors or computing devices. For example, the mapped information stored by the electronic data processor 202 can be received or transferred from other computers and or data collected from the imaging devices 153 arranged on the work vehicles 100 may be transferred to another a processor on another work vehicle 100. In some embodiments, the information/data may be transmitted via a network to a central processing computer for further processing. For example, a first vehicle may store a computerized model of a worksite (i.e., a map of the worksite) and the work to be performed at the work site by the implements.

Once a desired number of object obstructions 114 have been detected and mapped, the electronic data processor 202 can use such information to define one or more worksite warning zones 501 via the zone configuration module 234. The zone configuration module 234 can communicate with the mapping module 232 to classify and associate warning signals with the 2D and/or 3D models (i.e., generate worksite warning zones). In some embodiments, the worksite warning zones 501 can be classified as active (mobile) or inactive (stationary) depending upon the characteristics or the features of object obstructions 114 detected in the worksite 10. For example, object obstructions 114 such as site operators or pedestrians detected within the worksite 10 can be characterized as active, whereas object obstructions 114 such as ponds, buildings, or, utility poles can be characterized as inactive. Additionally, each of the object obstructions 114 can be further characterized as hazardous or non-hazardous based on the associated data.

In some embodiments, the electronic data processor 202 can query the detailed map info stored on the data storage device 206 to determine whether there is a warning zone 501 associated with the location of the identified first object. As previously discussed with reference to FIG. 3, the grade control system 226 can determine a position of the blade assembly 116 arranged on the work vehicle 100 and use such data as a reference point for determining geographic locations of the object obstructions 114 or images captured. In some embodiments, rather than having warning zones 501 generated in near real-time, an operator could define warning zones 501 via the user display 210 by utilizing stored data such as a zip file associated with a work tool. In such an embodiment, the vehicle operator could generate warning zones 501 by selecting three or “n” number of points 133 to make a plane around complex 3D object obstructions utilizing the user display 210. In other embodiments, a warning zone 501 could be created by having the work vehicle 100 travel along a road or path and create an offset from the edge of the blade assembly 116 or other work tools attached to the work vehicle 100. For example, in a quarry or mine, a high-wall berm can be used as a reference point for the creation of the offset. In still other embodiments, an operator such as a civil engineer or worksite manager can add metadata 135 or model/image layers 136 to maps and/or models stored in a database. For example, the model layers can be generated by the worksite manager utilizing one or more design files that include predetermined maps and/or models of the worksite 10.

Once the 2D and/or 3D models and corresponding warning zones 501 are generated, at 310, the electronic data processor 202 can again execute the zone configuration module 234 to generate one or more warning alerts 503 associated with the warning zones. At 312, in some embodiments, the warning alerts can be displayed on the user display 210 when the work vehicle 100 is proximate or within a predetermined range of the warning zones. For example, as shown in FIG. 5, an exemplary display such as map 500 can be displayed on the user display 210. The map 500 can comprise images of the warning zones 501 and associated warning alerts 503. This may include location information defining the boundaries of object obstructions 114 or off-limits areas located within the worksite 10. The warning zones 501 can include descriptions such as water obstruction, building obstruction, live work area, danger zone, or others, for example. In some embodiments, the map 500 can comprise multiple maps, each of which is generated in near real-time. In other embodiments, the maps 500 can be generated utilizing previously created maps stored in one or more databases 134. Additionally, in still other embodiments, the electronic data processor 202 is configured to generate a control signal 203 to change or inhibit an operation or work function of the work vehicle 100 based on the warning alerts 503 as previously discussed with reference to FIGS. 2 and 3.

Without in any way limiting the scope, interpretation, or application of the claims appearing below, a technical effect of one or more of the example embodiments disclosed herein is a system for configuring worksite warning zones. The zone configuration system is particularly advantageous in that it allows for near real-time configuration of worksite warning zones based on a detection of one or more object obstructions.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A warning zone system for a work vehicle, the warning zone system comprising:
an object detection system arranged on a work vehicle, wherein the object detection system is configured to detect and classify one or more object obstructions located at a worksite;
a zone configuration system, wherein the zone configuration system is configured to associate position data with the one or more object obstructions, and generate object models of the object obstructions based on the associated position data; and
an electronic data processor communicatively coupled to each of the object detection system and the zone configuration system, wherein the electronic data processor is configured to generate and associate warning zones with the object models for display on a user display in substantially real-time.

2. The warning zone system of claim 1, wherein the object obstructions are classified based on a plurality of object characteristics.

3. The warning zone system of claim 2, wherein the plurality of object characteristics comprises one or more of the following: object type, object size, object location, or combinations thereof.

4. The warning zone system of claim 1, wherein the electronic data processor is further configured to generate one or more warning alerts for display on the user display when the work vehicle is arranged proximate the warning zones.

5. The warning zone system of claim 4, wherein the electronic data processor is configured to generate a control signal to inhibit an operation of the work vehicle based on the one or more warning alerts.

6. The warning zone system of claim 1, wherein the warning zones are manually generated by an operator via the user display.

7. The warning zone system of claim 6, wherein manual generation of the warning zones comprises manual selection of a plurality of points around the object models by an operator for storage in a database.

8. The warning zone system of claim 6, wherein manual generation of the warning zones includes addition of metadata or image layers to the object models by the operator.

9. The warning zone system of claim 1, wherein the object detection system comprises at least one imaging device including one or more of the following: a camera, infrared imaging device, video recorder, lidar, radar, ultrasonic, stereo camera, or combinations thereof.

10. The warning zone system of claim 1, wherein the position data is received from a location determining receiver.

11. The warning zone system of claim 1, wherein the zone configuration system is further configured to generate the object models based on a comparative assessment of the object models to previously stored maps or models in a database.

12. The warning zone system of claim 1, wherein the zone configuration system associates position data of a blade assembly with the one or more object obstructions.

13. A method, the method comprising:
capturing at least one image of an object obstruction arranged in a worksite;
classifying the object obstruction based on a plurality of object characteristics;
associating position data with the object obstruction;
generating a model of the object obstruction;
generating and associating one or more warning zones with the object obstructions; and
displaying the warning zones on a user display in substantially real-time.

14. The method of claim 13, wherein capturing at least one image comprises capturing at least one image with an object detection system arranged on a work vehicle.

15. The method of claim 14, wherein the object detection system comprises at least one imaging device comprising one or more of the following: a camera, infrared imaging device, video recorder, lidar, radar, ultrasonic, stereo camera, or combinations thereof.

16. The method of claim 13, wherein the plurality of object characteristics comprises one or more of the following: object type, object size, object location, or combinations thereof.

17. The method of claim 13, wherein associating one or more warning zones with the object obstructions comprises manually associating the one or more warning zones by an operator via the user display.

18. The method of claim 16, wherein manually associating the one or more warning zones comprises manually selecting a plurality of points around the object models for storage in a database.

19. The method of claim 16, wherein manually associating the one or more warning zones comprises manually associating metadata or image layers to the object models.

20. The method of claim 13, wherein the electronic data processor is further configured to generate one or more warning alerts when the work vehicle is proximate or within a predetermined range of the warning zones.
